(19) United States
(12) Patent Application Publication
(10) Pub. No.: US 2024/0246354 A1
(43) Pub. Date: Jul. 25, 2024

(54) SYSTEM AND METHOD TO REDUCE BIRD COLLISIONS WITH A WINDOW

(71) Applicant: Griff and Associates, L.P., Fallsington, PA (US)

(72) Inventor: Timothy Roche, Bristol, PA (US)

(73) Assignee: Griff and Associates, L.P., Fallsington, PA (US)

(21) Appl. No.: 18/159,293

(22) Filed: Jan. 25, 2023

(51) Int. Cl. B44C 1/10

(52) U.S. Cl. CPC B44C 1/105

(57) ABSTRACT

A plurality of markers may be arranged in a grid patter to reduce the likelihood of bird collisions with windows or other transparent or translucent structure. The grid may be defined by a plurality of UV absorbing markers and a plurality of UV scattering or reflecting markers. This grid, as observed by a bird, forms a pattern of dark contrast and bright contrast spots on the window while remaining largely undetectable to the human eye. Some of the markers may be applied to window with an adhesive that has been UV tinted.

### TECHNICAL FIELD

This disclosure is directed to systems and articles of manufacture to prevent or reduce bird collisions with windows.

### BACKGROUND ART

Buildings have windows. Many building have large widows or sliding glass doors that take up area of the surrounding wall space. Birds may collide into these large windows. For example, the windows may reflect light from surrounding outside habitat. The birds are fooled by the reflections and fly into the windows causing injury and/or death. The number of birds that collide into windows has reached epidemic levels with bird mortality rates in the United States caused by window collisions reported at around 1,200,000,000 per year.

To avoid bird collisions, decals are placed on the outside of the windows to disrupt the reflected images. However, these decals have limited success preventing bird collisions. Chances of even moderate success require attaching a large numbers of the decals to the outside of the window.

### SUMMARY OF THE INVENTION

A need continues to exist for improved decals or markers that are placed on a window to reduce the likelihood of a bird collision with a window. The present disclosure addresses this need, amongst other needs.

In one aspect, an exemplary embodiment of the present disclosure may provide a system for reduce bird collisions with a window, the system comprising: a plurality of first markers that absorb ultraviolet (UV) light; a plurality of second markers that scatter or reflect UV light; wherein the plurality of first makers and the plurality of second markers are adapted to be applied to a window in a pattern to reduce bird collisions with the window. This exemplary embodiment or another exemplary embodiment may further provide that the pattern within which the plurality of first makers and the plurality of second markers are applied is a grid pattern. This exemplary embodiment or another exemplary embodiment may further provide a first row or column of markers, the first row or column being defined by spaced apart first markers; a second row or column of markers, the second row or column being defined by spaced apart second markers; and wherein the first row or column is spaced from the second row or column. This exemplary embodiment or another exemplary embodiment may further provide a third row or column of markers, the third row or column being defined by spaced apart first markers, wherein the third row or column is spaced from the first row or column and the second row or column. This exemplary embodiment or another exemplary embodiment may further provide a fourth row or column of markers, the fourth row or column being defined by spaced apart second markers, wherein the fourth row or column is spaced from the first row or column, the second row or column, and the third row or column.

This exemplary embodiment or another exemplary embodiment may further provide that at least one of the plurality of first markers comprises a film embedded with UV absorbing material. This exemplary embodiment or another exemplary embodiment may further provide that at least one of the plurality of first markers comprises a film; and a UV absorbing material applied to the film. This exemplary embodiment or another exemplary embodiment may further provide that at least one of the plurality of first markers comprises a UV absorbing film formed from a UV additive in the pelletized material used to form the UV absorbing film.

This exemplary embodiment or another exemplary embodiment may further provide that at least one of the plurality of second markers comprises a film embedded with UV scattering material. This exemplary embodiment or another exemplary embodiment may further provide that at least one of the plurality of second markers comprises a UV scattering film. This exemplary embodiment or another exemplary embodiment may further provide that at least one of the plurality of second markers comprises benzotrizole or hindered amine light stabilizer (HALS). This exemplary embodiment or another exemplary embodiment may further provide that at least one of the plurality of second markers comprises: a film; and a UV scattering material feature on the film. For example, the UV scattering feature can be hologram embossed onto the film.

This exemplary embodiment or another exemplary embodiment may further provide an adhesive applied to at least the first markers, wherein the adhesive comprises a UV tint. This exemplary embodiment or another exemplary embodiment may further provide that the UV tint is Spectra Pyranine Concentrate. This exemplary embodiment or another exemplary embodiment may further provide that an average concentration ratio of the UV tint to adhesive is in a range from about 1-3 ounces to 5 gallons.

In another aspect, another embodiment of the present disclosure may provide a method for reducing bird collisions with a window, the method comprising: providing a plurality of first markers that absorb UV light; providing a plurality of second markers that scatter UV light; and effecting the plurality of first makers and the plurality of second markers to be applied to a window in a pattern to reduce bird collisions with the window. This exemplary embodiment or another exemplary embodiment may further provide effecting the plurality of first makers and the plurality of second markers to be applied in a grid pattern. This exemplary embodiment or another exemplary embodiment may further provide effecting a first row or column of markers to be created, the first row or column being defined by spaced apart first markers; effecting a second row or column of markers to be created, the second row or column being defined by spaced apart second markers; and effecting the first row or column to be spaced from the second row or column. This exemplary embodiment or another exemplary embodiment may further provide effecting a third row or column of markers to be created, the third row or column being defined by spaced apart first markers; and effecting the third row or column to be spaced from the first row or column and the second row or column. This exemplary embodiment or another exemplary embodiment may further provide effecting a fourth row or column of markers to be created, the fourth row or column being defined by spaced apart second markers; and effecting the fourth row or column to be spaced from the first row or column, the second row or column, and the third row or column.

This exemplary embodiment or another exemplary embodiment may further provide fabricating a film embedded with UV absorbing material. This exemplary embodiment or another exemplary embodiment may further provide fabricating a film; and applying a UV absorbing material to the film. This exemplary embodiment or another exemplary embodiment may further provide fabricating a UV absorbing film.

This exemplary embodiment or another exemplary embodiment may further provide fabricating a film embedded with UV scattering material. This exemplary embodiment or another exemplary embodiment may further provide fabricating a UV scattering film. This exemplary embodiment or another exemplary embodiment may further provide fabricating a film; and creating a UV scattering feature on the film. For example, creating the UV scattering feature may be accomplished by embossing or hologram embossing the UV scattering feature onto the film.

This exemplary embodiment or another exemplary embodiment may further provide adding a UV tint to an adhesive to achieve a desired concentration ratio of UV tint to adhesive; and applying the UV tinted adhesive. This exemplary embodiment or another exemplary embodiment may further provide that the desired concentration ratio of UV tint to adhesive is in a range from about 1-3 ounces to 5 gallons.

In yet another aspect, another embodiment of the present disclosure may provide a method for reducing bird collisions with a window, the method comprising: obtaining a plurality of first markers that absorb UV light; obtaining a plurality of second markers that scatter or reflect UV light; and applying the plurality of first makers and the plurality of second markers to a window in a grid pattern to reduce bird collisions with the window, wherein applying the plurality of first makers and the plurality of second markers to the window in the grid pattern includes: creating a first row or column of markers, the first row or column being defined by spaced apart first markers; creating a second row or column of markers, the second row or column being defined by spaced apart second markers; and spacing the first row or column from the second row or column. This exemplary embodiment or another exemplary embodiment may further provide creating a third row or column of markers, the third row or column being defined by spaced apart first markers; and spacing the third row or column from the first row or column and the second row or column. This exemplary embodiment or another exemplary embodiment may further provide creating a fourth row or column of markers, the fourth row or column being defined by spaced apart second markers; and spacing the fourth row or column from the first row or column, the second row or column, and the third row or column. This exemplary embodiment or another exemplary embodiment may further provide that at least one of the first markers comprises a first film embedded with UV absorbing material; and wherein at least one of the second markers comprises a second film and a UV scattering feature on the second film. This exemplary embodiment or another exemplary embodiment may further provide that the UV scattering feature has been hologram embossed onto the film.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a diagrammatic perspective view of a bird flying near a window in a building or structure.

FIG. 2 is a front elevation view of the window having decals or markers, as would be observable to a bird, to reduce the likelihood of bird collisions according to an exemplary aspect of one embodiment of the present disclosure.

FIG. 3 is a front elevation view of the window having decals or markers of FIG. 2, which are transparent or translucent to a human observer and otherwise largely undetectable, to reduce the likelihood of bird collisions according to an exemplary aspect of one embodiment of the present disclosure.

FIG. 4 is a cross section view taken along line 4-4 in FIG. 2 depicting the marker applied to the window.

FIG. 5 is a front elevation view of the window having decals or markers, as would be observable to a bird in an alternating pattern of reflective and absorbing markers, to reduce the likelihood of bird collisions according to an exemplary aspect of another embodiment of the present disclosure.

FIG. 6 is a front elevation view of the window having decals or markers of FIG. 5, which are transparent or translucent to a human observer and otherwise largely undetectable, to reduce the likelihood of bird collisions according to an exemplary aspect of another embodiment of the present disclosure.

FIG. 7 is a cross section view taken along line 7-7 in FIG. 5 depicting the marker applied to the window.

FIG. 8 is a cross section view of an alternative embodiment of an embossing technique for the marker applied to the window.

Similar numbers refer to similar parts throughout the drawings.

### DETAILED DESCRIPTION

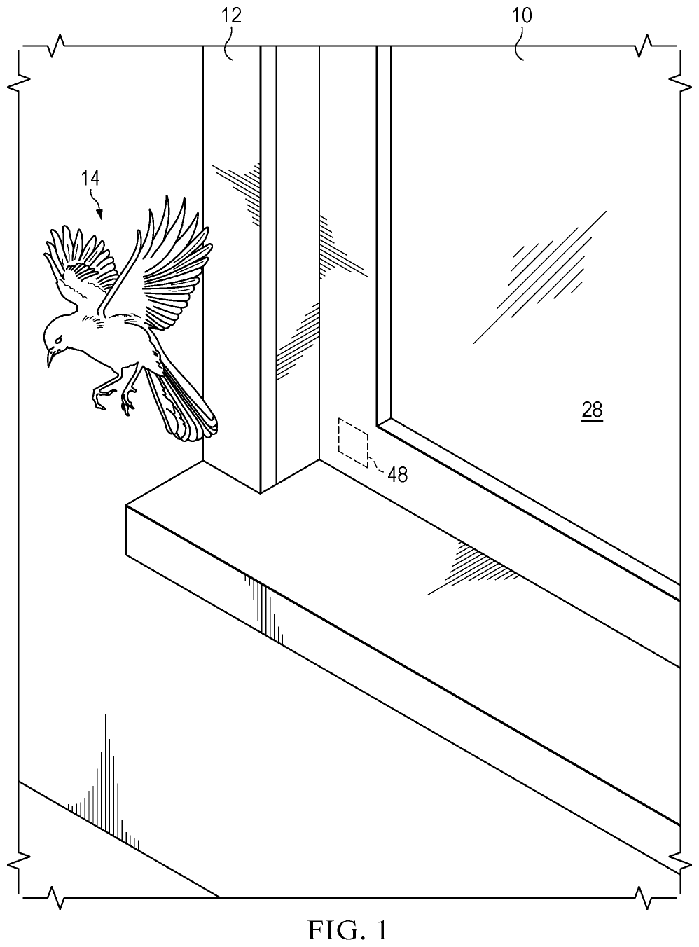

FIG. 1 diagrammatically depicts a window 10 mounted within a building 12. Typically, the window 10 includes an exterior surface and an interior surface. Further, the window 10 is formed from a transparent or translucent material, such as glass or a polymer (i.e., acrylic). Because the window 10 is transparent or translucent, birds, such as bird 14, have difficulty detecting the glass or acrylic/polymer of material of window 10 while they are flying. Birds have a tendency to collide with windows 10 in an attempt to fly though them because the presence of the material defining the window 10 is unbeknownst to them. Bird collisions can be detrimental to the structure of the window 10. Namely, when bird 14 collides with window 10 it can crack or shatter or otherwise damage the glass or polymer material of window 10.

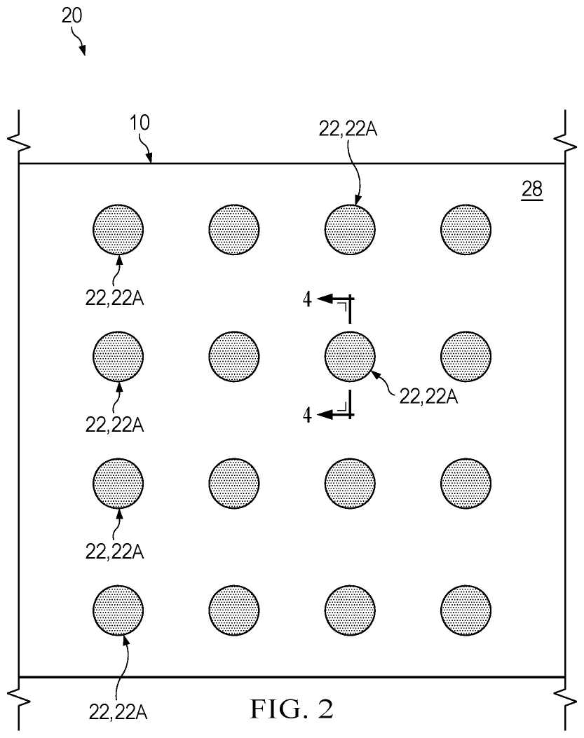

FIG. 2 depicts a first embodiment of a system 20. System 20 comprises a plurality of decals or markers 22 that are applied to the transparent or translucent material of window 10, typically on the exterior surface thereof, that are visible to bird 14 but otherwise not visible to the human eye. The human eye is typically only able to observe bands of light waves (i.e., wavebands) that range from about 420 nanometers (nm) to 750 nm (i.e., the human-observable light spectrum). Notably, there are other references that indicate that the human-observable light spectrum extends down to about 380 nanometers, however there are few humans that can actually detect these wavebands, and most humans cannot detect wavebands below about 420 nm. Particularly, the inventors tested and determined that markers 22 that operate around 415 nm perform optimally and are still largely undetectable to the human eye. As such, the markers 22 operate at wavebands that are outside or very close to being outside the range of human observable light spectrum. In one particular embodiment, the plurality of markers operate in the ultraviolet spectrum of light. Typically, the ultraviolent (UV) spectrum of light ranges from about 100 nm to about 420 nm. It is understood that the UV spectrum, or at least a portion of the UV spectrum is observable to bird 14.

With continued reference to FIG. 2, the markers 22 depict a plurality of first markers 22A. At least one of the first markers 22A is a marker that absorbs UV light such that the marker appears as a dark spot or a dark element as observed by bird 14 but is otherwise unobservable to the human eye.

The plurality of first markers 22A are arranged in a grid pattern or array defined by columns and rows of individual first markers. For example, as shown in FIG. 2 there is an array formed of four columns and four rows of spaced apart first markers applied to the exterior surface of window 10. As described in greater detail below, the manner in which the markers are applied to the glass or support structure of window 10 may be accomplished via and adhesive. The adhesive should be clear when it is curd so that the window can remain transparent as observed by the human eye.

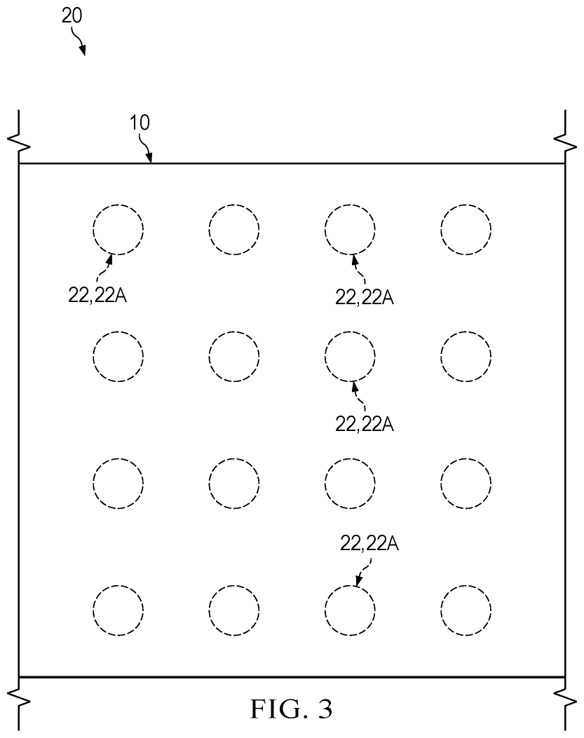

FIG. 3 diagrammatically depicts the transparency of the window 10 as observed by the human eye when the plurality of markers 22, namely, the plurality of first markers 22A are applied to window 10. Particularly, when the first markers 22A are arranged in a pattern, such as the grid pattern, they are transparent or translucent to the human eye such that the window 10 is observable to a human as a normal window and the markers are largely or wholly undetectable to the human observer. The transparency or translucency of the markers 22 is represented by dashed-lines in FIG. 3. Because the markers 22 are not visible or largely undetectable to the human observer, they may occupy more than 15% of the surface area of the window. For example, the sum of all the areas of all markers 22 on window 10 may be greater than 15% of the surface area of the exterior surface 28 of window 10. the sum of all the areas of all markers 22 on window 10 may be greater than 20% of the surface area of the exterior surface 28 of window 10. In another embodiment, the sum of all the areas of all markers 22 on window 10 may be greater than 25% of the surface area of the exterior surface 28 of window 10. the sum of all the areas of all markers 22 on window 10 may be greater than 35% of the surface area of the exterior surface 28 of window 10. the sum of all the areas of all markers 22 on window 10 may be greater than 45% of the surface area of the exterior surface 28 of window 10. the sum of all the areas of all markers 22 on window 10 may be greater than 50% of the surface area of the exterior surface 28 of window 10. the sum of all the areas of all markers 22 on window 10 may be greater than 75% of the surface area of the exterior surface 28 of window 10.

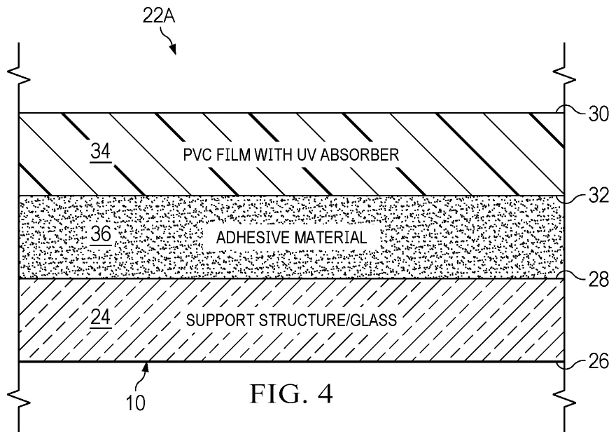

FIG. 4 depicts an enlarged cross-section view of the first marker 22A applied to a material or support structure 24, which as stated previously can be glass or a polymer/acrylic. Support structure 24 of window 10 includes an interior surface 26 and an exterior surface 28. First marker 22A includes a first surface 30 opposite a second surface 32 that are defined by a body 34. The body 34 is primarily defined by or formed of a film. In one particular embodiment, the film of body 34 may be a polyvinylchloride (PVC film). The PVC film or other type of material defining body 34 may be embedded with a UV absorbing material that causes the first markers 22A to appear in dark contrast, as observed by bird 14, when applied to the exterior surface 28 of support structure 24 of window 10. Alternatively, the body 34 of the film may have UV absorbing properties. In another embodiment, the body 34 of the film may have a UV absorbing material applied to the first surface 30, the second surface 32, or both. In one embodiment, there is a UV absorbing additive package added to the PVC pellets that are utilized to make or extruded the PVC film defining body 34 such as a benzotrizole or hindered amine light stabilizer (HALS), among others. Some exemplary HALS compounds that may suffice include: HALS UV-770 (CAS No.: 52829-07-9), HALS UV-3853, HALS UV-292 (CAS No.: 41556-26-7; 82919-37-7), HALS UV-123 (CAS No.: 129757-67-1), HALS UV-944 (CAS No.: 70624-18-9; 71878-19-8); HALS UV-622 (CAS No.: 65447-77-0); or HALS UV-119 (CAS No.: 106990-43-6). Some UV absorbing material that may also suffice include Absorbers UV-326 (CAS No.: 3896-11-5), Absorbers UV-327 (CAS No.: 3846-99-1); Absorbers UV-328 (CAS No.: 25973-55-1), Absorbers UV-329 (CAS No.: 3147-75-9); Absorbers UV-P (CAS No.: 2440-22-4), Absorbers UV-360 (CAS No.: 103597-45-1), Absorbers UV-234 (CAS No.: 70321-86-7), Absorbers UV-928 (CAS No.: 73936-91-1), Absorbers UV-1130 (CAS No. 104810-48-2/104810-47-1/25322-68-3), Absorbers UV384-2 (CAS No.: 127519-17-9; 108-65-6), Absorbers UV-400 (CAS No.: 153519-44-9; 107-98-2); Absorbers UV-405 (CAS No.: 137658-79-8); Absorbers UV-1164 (CAS No.: 2725-22-6), Absorbers UV-1164 (CAS No.: 2725-22-6), Absorbers UV-1577 (CAS No.: 147315-50-2), or Absorbers UV-531 (CAS No.:1843-05-6). This absorbing compound or material or additive to the film body 34 appears as a dark spot to bird 14. It has been empirically determined found that absorbing a wavelength at 412 nm is the most effective for system 20, however any absorbing wavelength in a range from about 370 to about 430 nm is suitable for marker 22A.

The adhesive material or adhesive 36 is interposed between second surface 32 of body 34 and the exterior surface 28 of support structure 24 of window 10. Notably, FIG. 4 is not shown to scale and the adhesive material 36 maybe thinner than the thickness of the film or body 34 measured between the first surface 30 and the second surface 32. Additionally, the adhesive 36 may be thinner than the thickness of the support structure 24 or glass of window 10 measured between the exterior surface 28 and the interior surface 26.

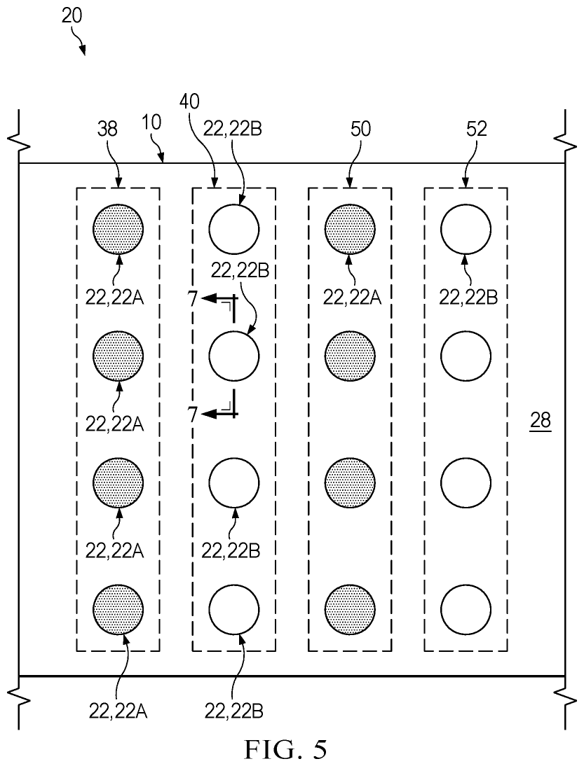

FIG. 5 depicts a second embodiment of the system 20. System 20 comprises a plurality of decals or markers 22 that are applied to the transparent or translucent glass or support structure 24 of window 10. The markers 22 of the second embodiment comprise a plurality of first markers 22A and a plurality of second markers 22B. At least one of the first markers 22A is a marker that absorbs UV light such that the marker appears as a dark spot or a dark element as observed by bird 14 but is otherwise unobservable to the human eye. At least one of second markers 22B is a marker that scatters or reflects UV light such that the marker appears as a white/bright spot or a bright element as observed by bird 14 but is otherwise unobservable to the human eye.

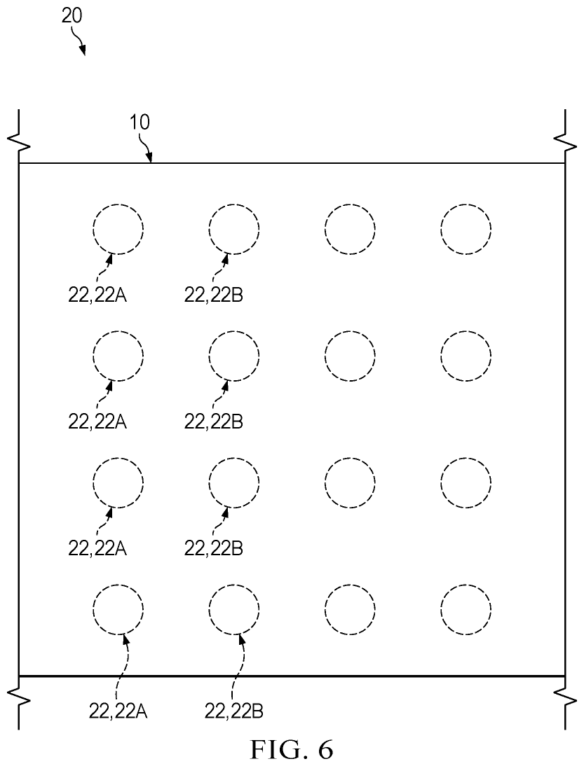

The plurality of first markers 22A and the plurality of second markers 22B are arranged in a grid pattern or array defined by columns and rows of individual first markers. For example, as shown in FIG. 6 there is an array formed of four columns and four rows of spaced apart first markers applied to the exterior surface of window 10. As described in greater detail below, the manner in which the markers are applied to the glass or support structure of window 10 may be accomplished via and adhesive. The adhesive should be clear when it is cured so that the window can remain transparent as observed by the human eye. In this embodiment, there is a first column 38 of first markers 22A and a second column 40 of second markers 22B. This could be an alternative configuration such that there is a first row or column of first markers 22A and a second row or column of second markers 22B. Alternatively, the columns may be composed of alternating first markers 22A and second markers 22B. Further alternatively, the rows or columns may be composed of alternating first markers 22A and second markers 22B.

FIG. 6 diagrammatically depicts the transparency of the window 10 as observed by the human eye when the plurality of markers 22, namely, the plurality of first markers 22A and second marker 22B are applied to window 10. Particularly, when the first markers 22A and second markers 22B are arranged in a pattern, such as the grid pattern, they are transparent or translucent to the human eye such that the window 10 is observable to a human as a normal window and the markers are largely or wholly undetectable to the human observer. The transparency or translucency of the markers 22A and 22B is represented by dashed-lines in FIG. 6. However, it should be noted that since the markers 22A and 22B appear as clear dots (or whatever shape the marker takes) a human would be able to detect the physical presence of a clear film on the window, but it appears colorless clear, translucent or transparent to the human observer.

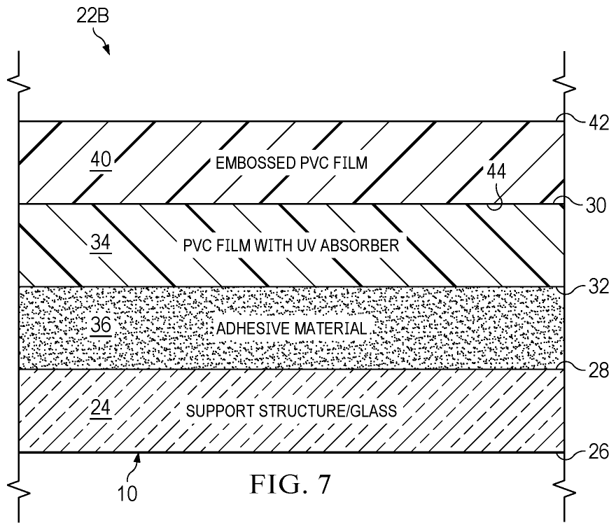

FIG. 7 depicts an enlarged cross-section view of the second marker 22B applied to a material or support structure 24, which as stated previously can be glass or a polymer/acrylic. Support structure 24 of window 10 includes the interior surface 26 and the exterior surface 28. Second marker 22B includes the first surface 30 opposite the second surface 32 that are defined by body 34. The adhesive material or adhesive 36 is interposed between second surface 32 of body 34 and the exterior surface 28 of support structure 24 of window 10. Notably, FIG. 7 is not shown to scale and the adhesive material 36 maybe thinner than the thickness of the film or body measured between the first surface and the second surface. Additionally, the adhesive 36 may be thinner than the thickness of the support structure 24 or glass of window 10 measured between the exterior surface 28 and the interior surface 26. There may be a second body 40 defining a third surface 42 and a fourth surface 44. The fourth surface 44 abuts the first surface 30 of body 34. Second body 40 is primarily defined by or formed of a film. In one particular embodiment, the film of second body 40 may be a second PVC film. The PVC film or other type of material defining second body 40 may be embedded with a UV reflecting or scattering material that causes the second markers 22B to appear in bright contract, as observed by bird 14, when applied to the exterior surface 28 of support structure 24 of window 10. Alternatively, the second body 40 of the film may have UV reflecting or scattering properties. In another embodiment, the second body 40 of the second PVC film may have a UV scattering material applied to the third surface 42, the fourth surface 44, or both.

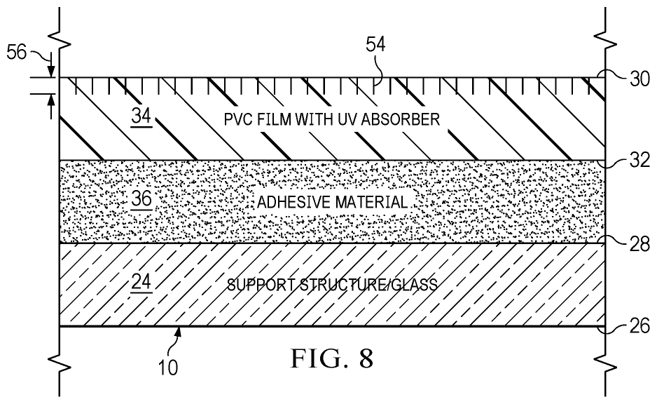

FIG. 8 depicts another embodiment in which the UV scattering effect of second markers 22B may be accomplished by utilizing an emboss 54, which may also be a hologram emboss 54, in the body 34. The emboss 54 is accomplished by mechanically altering the first surface 30 to impart the UV scattering effect. In this particular embodiment, at least one of the second markers 22B may be an embossed hologram or formed by a hologram embossing process to scatter the UV light. There are multiple ways to emboss the film to achieve the proper reflection including an engraved roller that the extrudate runs across and the belt method of using an existing embossed film to transfer the pattern. In another embodiment, the embossing establishes an interference pattern, for example a holographic image, in which the interference pattern is introduced into a transparent layer situated on a plastic base or PVC film defining film body 34. The depth 56 of the emboss 54 is based on or depends on the desired wavelength to be reflected or scattered. The depth of the emboss may range depending on design. In one embodiment, the depth of the emboss may be in a range from about 10 nm to about 250 nm into the surface 30 of film or body 34. Optionally, there may be a resin layer containing a diffractive pattern is covered with a polyester film. In order to make a transfer film (i.e., a hot-stamping foil) said polyester film may be treated for moderate adhesion to the resin layer, so that the resin layer will remain attached until it is later adhered to another surface. The moderate adhesion of the polyester film to the resin layer may be obtained by applying a separate release layer on the plastic base film and subsequently applying the resin layer on the release layer.

In some instances, it may be beneficial to add a slight UV coloring to the system. In this instance, the marker, such as first marker 22A or second marker 22B, would still be translucent but and colorless clear, transparent or translucent to the human eye if a UV tint, dye or other substance is applied to the adhesive. Regarding the adhesive in this scenario (or other embodiments), it can be any type of adhesive, such as a pressure sensitive adhesive (PSA). In one embodiment, the PSA is an acrylate-based PSA. The PSA can be UV tinted with a color when exposed to UV light that would be observable to the bird but not a human. For example, the adhesive can be tinted with a Spectra Pyranine Concentrate which results in a slightly fluorescent yellow green that is imparted in the area covered by the marker to make that marker/adhesive combination visible to the bird but not to the human eye. The Spectra Pyranine Concentrate is a UV reflector that may be added to the adhesive. The average concentration ratio of Spectra Pyranine Concentrate to adhesive is in a range from about 1-3 ounces to 5 gallons. However, this concentration could be increased to increase the lifespan of the UV tint. The increased concentration of the UV tint may allow for the UV tint to have a concentration that is up to 10% of the adhesive.

Any of the markers 22 discussed herein may take the form of any shape. Thus, although the markers are shown herein generally as circular dots, it is to be understood that any other geometric configuration of the markers 22 is entirely possible. For example, instead of the markers being circular dots, the markers 22 can be triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, 0-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

The device, assembly, or system 20 of the present disclosure may additionally include one or more sensors 48 to sense or gather data pertaining to the surrounding environment or operation of the device, assembly, or system. Some exemplary sensors 48 capable of being electronically coupled with the device, assembly, or system of the present disclosure (either directly connected to the device, assembly, or system of the present disclosure or remotely connected thereto) may include but are not limited to: a camera or optical sensor to image birds near the window; accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; Global Positioning sensors sensing location, elevation, distance traveled, velocity/speed; audio sensors sensing local environmental sound levels, or voice detection; Photo/Light sensors sensing ambient light intensity, ambient, Day/night, UV exposure; TV/IR sensors sensing light wavelength; Temperature sensors sensing machine or motor temperature, ambient air temperature, and environmental temperature; and Moisture Sensors sensing surrounding moisture levels.

The device, assembly, or system of the present disclosure may include wireless communication logic coupled to sensors 48 on the system. The sensors 48 gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wifi, ZigBee, MiWi, Bluetooth) for communication. In one example, each of the devices, assemblies, or systems of the present disclosure may have its own IP address and may communicate directly with a router or gateway. This would typically be the case if the communication protocol is WiFi.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system that receives and processes signals from the device, assembly, or system of the present disclosure may differ from embodiment to embodiment. In one embodiment, alerts and signals from the device, assembly, or system 20 of the present disclosure, for example if a bird were to collide with the window, are sent through an e-mail or simple message service (SMS; text message) gateway so that they can be sent as e-mails or SMS text messages to a remote device, such as a smartphone, laptop, or tablet computer, monitored by a responsible individual, group of individuals, or department, such as a maintenance department. Thus, if a particular device, assembly, or system of the present disclosure creates an alert because of a data point gathered by one or more sensors, that alert can be sent, in e-mail or SMS form, directly to the individual responsible for fixing it (e.g., an alert to cause someone to check the integrity of the window subsequent to a bird strike, if it occurs even with the markers 22 being applied to the window). Of course, e-mail and SMS are only two examples of communication methods that may be used; in other embodiments, different forms of communication may be used.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

For example, the system 20 may be operationally effectuated by performing a process to install the markers 22 on the glass or structure 24 of window 10. In this instance, the method for reducing bird collisions with a window may operate by obtaining a plurality of first markers 22A that absorb ultraviolet (UV) light and obtaining a plurality of second markers 22B that scatter UV light. Obtaining the markers is typically accomplished by purchasing the markers 22A and markers 22B as part of a kit. The markers 22A and markers 22B may be provided on a releasable backing and include instructions to the user to apply them to the exterior surface 28 of window 10. Alternatively, it is also possible for the instructions to indicate that the markers are to be installed on the interior surface 30 of window 10.

Once the markers have been obtained and removed from the backing, then the method may operate by applying the plurality of first makers 22A and the plurality of second markers 22B to window 10 in a pattern to reduce bird 14 collisions with the window 10. The application of the plurality of first makers 22A and the plurality of second markers 22B may be accomplished by the end user or purchaser of the kit or system 20. The plurality of first makers 22A and the plurality of second markers 22B are aligned with the window to adhere them to the exterior surface 28 of window 10 via adhesive 36.

The pattern in which the plurality of first makers 22A and the plurality of second markers 22B are applied to the window 10 may be selectively chosen by the user. However, it is envisioned that the user will be instructed to apply the plurality of first makers 22A and the plurality of second markers 22B in the grid pattern shown in FIG. 5 or otherwise described herein. By arranging the plurality of first makers 22A and the plurality of second markers 22B in the alternating columns or rows, it should provide a sufficient deterrent of bird 14 away from window 10 thereby reducing the likelihood of a collision. For example, when creating the grid pattern detailed herein, a user creates the first row or column 38 of markers 22A, the first row or column 38 being defined by spaced apart first markers 22A. Then, the user creates a second row or column 40 of markers 22B, the second row or column 40 being defined by spaced apart second markers 22B. In this instance, the user spaces the first row or column 38 from the second row or column 40. Notably, the usage of the term row and column may vary depending on the orientation of the window 10. For example, the arrangement shown in FIG. 5 would be equally effective if the grid was rotated 90 degrees such that horizontal rows were formed of first markers 22A and second markers 22B.

When more of the plurality of first makers 22A and the plurality of second markers 22B are used, the user may continue this process and create a third row or column 50 of markers 22A, the third row or column 50 being defined by spaced apart first markers 22A. Then, the user the third row or column from the first row and the second row. This may continue such that the user creates a fourth row or column 52 of markers 22B, the fourth row or column 52 being defined by spaced apart second markers 22B. Then the user spaces the fourth row or column 52 from the first row or column 38, the second row or column 40, and the third row or column 50.

Another method envisioned by the present disclosure is a process of the manufacturer of system 20. The manufacturer's method includes providing or fabricating a plurality of first markers 22A that absorb UV light; providing or fabricating a plurality of second markers 22B that scatter UV light; and effecting the plurality of first makers and the plurality of second markers to be applied to a window in a pattern to reduce bird collisions with the window by a user. Effecting this the plurality of first makers and the plurality of second markers to be applied to window 10 may be accomplished by supplying the system 20 as a kit to the end user (i.e., the manufacturers direct or indirect customer). This method may further include effecting the plurality of first makers and the plurality of second markers to be applied in a grid pattern. Namely, effecting a first row or column of markers to be created, the first row or column being defined by spaced apart first markers; effecting a second row or column of markers to be created, the second row or column being defined by spaced apart second markers; effecting a third row or column of markers to be created, the third row or column being defined by spaced apart first markers; effecting a fourth row or column of markers to be created, the fourth row or column being defined by spaced apart second markers; and effecting the fourth row or column to be spaced from the first row or column, the second row or column, and the third row or column.

In this embodiment, the manufacturer performs the method of fabricating a film embedded with UV absorbing material; or fabricating a film and applying a UV absorbing material to the film; or fabricating a UV absorbing film; or fabricating a film embedded with UV scattering material; or fabricating a UV scattering film; or fabricating a film and applying a UV scattering material to the film; or embossing the UV scattering material onto the film; or hologram embossing the UV scattering material onto the film.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A method for reducing bird collisions with a window, the method comprising:
providing a plurality of first markers that absorb ultraviolet (UV) light;
providing a plurality of second markers that scatter UV light; and
effecting the plurality of first makers and the plurality of second markers to be applied to a window in a pattern to reduce bird collisions with the window.

2. The method of claim 1, further comprising:
effecting the plurality of first makers and the plurality of second markers to be applied in a grid pattern.

3. The method of claim 1, further comprising:
effecting a first row or column of markers to be created, the first row or column being defined by spaced apart first markers;
effecting a second row or column of markers to be created, the second row or column being defined by spaced apart second markers; and
effecting the first row or column to be spaced from the second row or column.

4. The method of claim 3, further comprising:
effecting a third row or column of markers to be created, the third row or column being defined by spaced apart first markers; and
effecting the third row or column to be spaced from the first row or column and the second row or column.

5. The method of claim 4, further comprising:
effecting a fourth row or column of markers to be created, the fourth row or column being defined by spaced apart second markers;
effecting the fourth row or column to be spaced from the first row or column, the second row or column, and the third row or column.

6. The method of claim 1, wherein prior to providing the plurality of first markers and prior to providing the plurality of second markers comprises:
fabricating a film embedded with UV absorbing material.

7. The method of claim 1, wherein prior to providing the plurality of first markers and prior to providing the plurality of second markers comprises:
fabricating a film; and
applying a UV absorbing material to the film.

8. The method of claim 1, wherein prior to providing the plurality of first markers and prior to providing the plurality of second markers comprises:
fabricating a UV absorbing film.

9. The method of claim 1, wherein prior to providing the plurality of first markers and prior to providing the plurality of second markers comprises:
fabricating a film embedded with UV scattering material.

10. The method of claim 1, wherein prior to providing the plurality of first markers and prior to providing the plurality of second markers comprises:
fabricating a UV scattering film.

11. The method of claim 1, wherein prior to providing the plurality of first markers and prior to providing the plurality of second markers comprises:
fabricating a film; and
creating a UV scattering feature on the film.

12. The method of claim 11, further comprising:
embossing the UV scattering feature onto the film.

13. The method of claim 12, further comprising:
hologram embossing the UV scattering feature onto the film to a depth that is in a range from 10 nanometers (nm) to 250 nm from a surface of the film.

14. The method of claim 1, further comprising:
adding a UV tint to an adhesive to achieve a desired concentration ratio of UV tint to adhesive; and
applying the UV tinted adhesive.

15. The method of claim 14, wherein the desired concentration ratio of UV tint to adhesive is in a range from about 1-3 ounces to 5 gallons.

16. A method for reducing bird collisions with a window, the method comprising:
obtaining a plurality of first markers that absorb ultraviolet (UV) light;
obtaining a plurality of second markers that scatter UV light; and
applying the plurality of first makers and the plurality of second markers to a window in a grid pattern to reduce bird collisions with the window, wherein applying the plurality of first makers and the plurality of second markers to the window in the grid pattern includes:
creating a first row or column of markers, the first row or column being defined by spaced apart first markers;
creating a second row or column of markers, the second row or column being defined by spaced apart second markers; and
spacing the first row or column from the second row or column.

17. The method of claim 16, wherein applying the plurality of first makers and the plurality of second markers to the window in the grid pattern includes further comprises:
creating a third row or column of markers, the third row or column being defined by spaced apart first markers; and
spacing the third row or column from the first row or column and the second row or column.

18. The method of claim 17, wherein applying the plurality of first makers and the plurality of second markers to the window in the grid pattern includes further comprises:
creating a fourth row or column of markers, the fourth row or column being defined by spaced apart second markers; and
spacing the fourth row or column from the first row or column, the second row or column, and the third row or column.

19. The method of claim 16, wherein at least one of the first markers comprises a first film embedded with UV absorbing material; and wherein at least one of the second markers comprises a second film and a UV scattering feature on the second film.

20. The method of claim 16, wherein the UV scattering feature has been hologram embossed onto the film to a depth that is in a range from 10 nm to 250 nm from a surface of the film.
